(19) United States
(12) Patent Application Publication
(10) Pub. No.: US 2018/0233763 A1
(43) Pub. Date: Aug. 16, 2018

(54) COPPER BASED FLOW BATTERIES

(71) Applicant: CASE WESTERN RESERVE UNIVERSITY, Cleveland, OH (US)

(72) Inventors: Jesse WAINRIGHT, Willoughby Hills, OH (US); Robert SAVINELL, Solon, OH (US); Krista HAWTHORNE, Cleveland Heights, OH (US); Nicholas SINCLAIR, Amherst, OH (US); Tyler PETEK, Cleveland Heights, OH (US); Elizabeth FREUND, Shaker Heights, OH (US)

(21) Appl. No.: 15/512,079

(22) PCT Filed: Sep. 17, 2015
(86) PCT No.: PCT/US2015/050676

§ 371 Date: Mar. 17, 2017

(51) Int. Cl. H01M 8/18; H01M 10/36; H01M 12/08; H01M 8/22; H01M 8/04; H01M 4/00

(52) U.S. Cl. CPC H01M 8/188; H01M 10/36; H01M 12/08; H01M 2300/0002; H01M 8/04; H01M 4/00; H01M 8/225

(57) ABSTRACT

A copper based redox flow cell. In one aspect, the present technology provides a copper based flow battery comprising a first half-cell comprising a first electrolyte providing a source of ions and an electrode disposed within the first half-cell, a second half-cell comprising a second electrolyte providing a source of Cu²⁺ and Cu⁺ ions and an electrode disposed within the second half-cell, a separator between the first and second half-cells.

### CROSS-REFERENCE TO RELATED APPLICATIONS

The present application claims the benefit of U.S. Provisional Application No. 62/051,817 entitled “Copper Based Flow Batteries,” filed on Sep. 17, 2014, the disclosure of which is incorporated herein by reference in its entirety.

### BACKGROUND

Reduction-oxidation (redox) flow batteries store electrical energy in a chemical form and subsequently dispense the stored energy in an electrical form via a spontaneous reverse redox reaction. A redox flow battery is an electrochemical storage device in which an electrolyte containing one or more dissolved electroactive species flows through a reactor cell where chemical energy is converted to electrical energy. Conversely, the discharged electrolyte can be flowed through a reactor cell such that electrical energy is converted to chemical energy. The electrolytes used in flow batteries are generally composed of ionized metal salts that are stored in large external tanks and are pumped through each side of the cell according to the charge/discharge current applied. Externally stored electrolytes can be flowed through the battery system by pumping, gravity feed, or by any other method of moving fluid through the system. The reaction in a flow battery is reversible, and the electrolyte can be recharged without replacing the electroactive material. The energy capacity of a redox flow battery, therefore, is related to the total electrolyte volume, e.g., the size of the storage tank. The discharge time of a redox flow battery at full power also depends on electrolyte volume and often varies from several minutes to many days.

The minimal unit that performs the electrochemical energy conversion is generally called a “cell,” whether in the case of flow batteries, fuel cells, or secondary batteries. A device that integrates many such cells, coupled electrically in series or parallel, to get higher current or voltage or both, is generally called a “battery.” As used herein, the term “battery” may refer to a single electrochemical cell or a plurality of electrically coupled cells. Like traditional batteries, cells may be “stacked” together in a flow battery system to achieve the desired power output. Thus, the terms “cell” and “battery” can be used interchangeably herein.

Since the electrolyte is stored externally, the amount of energy that can be stored by a flow battery is largely determined by the solubility of the chemicals and the size of the tanks. The size of the tanks and storage capacity can be easily scaled. A true flow battery has all chemical species flowing through the battery and stored in external tanks and thus the energy and volume capacities can be sized independently. The vanadium redox flow battery is an example of a true flow battery and has received the most attention in recent years. In a hybrid flow battery, at least one of the chemical states resides within the stack such as by plating out as a metal. One example of a hybrid flow battery is a zinc-bromine battery, where the zinc metal is plated out. In these systems, the power and energy capacities are coupled, and the plating density affects the energy/power capacity ratio.

Redox flow batteries can be utilized in many technologies that require the storage of electrical energy. For example, redox flow batteries can be utilized for storage of night-time electricity (which is inexpensive to produce) to subsequently provide electricity during peak demand when electricity is more expensive to produce or demand is beyond the capability of current production. Such batteries can also be utilized for storage of green energy, i.e., energy generated from renewable sources such as wind, solar, wave, or other non-conventional sources.

Many devices that operate on electricity are adversely affected by the sudden removal of their power supply. Flow redox batteries can be utilized as uninterruptible power supplies in place of more expensive backup generators. Efficient methods of power storage can be used to construct devices having a built-in backup that mitigates the effects of power cuts or sudden power failures. Power storage devices can also reduce the impact of a failure at a generating station.

Other situations where uninterruptible power supplies can be of importance include, but are not limited to, buildings where uninterrupted power is critical, such as hospitals. Such batteries can also be utilized for providing an uninterruptible power supply in developing countries, many of which do not have reliable electrical power sources, resulting in intermittent power availability. Another possible use for redox flow batteries is in electric vehicles. Electric vehicles can be rapidly “recharged” by replacing the electrolyte. The electrolyte can be recharged separately from the vehicle and reused.

### SUMMARY

The present technology provides a copper based flow battery. A copper flow battery in accordance with aspects the present technology can provide a power source exhibiting sufficiently high cell voltages and excellent coulombic and voltaic efficiencies. A copper flow battery also provides a battery and system that is significantly cheaper than conventional based redox flow batteries such as vanadium based redox flow batteries or hybrid flow batteries such as zinc based flow batteries.

In one aspect, the present technology provides a copper based flow battery comprising a cathodic half-cell comprising a first electrolyte providing a source of ions for a cathodic redox couple and an electrode disposed within the cathodic half-cell; an anodic half-cell comprising a second electrolyte providing a source of Cu¹⁺ ions and an electrode disposed within the anodic half-cell; and a separator between the first and second half-cells.

In one embodiment, the cell further comprises a first storage tank external to the first half-cell for circulating the first electrolyte to and from the first half-cell; and a second storage tank external to the second half-cell for circulating the second electrolyte to and from the second half-cell.

In one embodiment, the present technology provides a battery comprising one or more of the redox flow cells described above.

### DESCRIPTION OF THE DRAWINGS

FIG. 1 is a schematic representation of a flow battery consistent with embodiments of the present technology;

FIG. 2 is a cyclic voltammogram for the Cu^{+2/0} and Cu^{+2/+1/0} oxidation/reduction at a graphite electrode;

FIG. 3 is a graph of hydrogen evolution on Cu at pH=1 in chloride and sulfate electrolytes;

FIG. 4 is a graph of polarization curves for Fe—Cu chloride batteries;

FIG. 5 is a graph of the voltaic and coulombic efficiencies of Cu—Fe—Cl batteries with Daramic and Nafion 117 separators;

FIG. 6 is a cyclic voltammogram of copper bromide electrolyte at a graphite electrode;

FIG. 7 is a cyclic voltammogram of a copper bromide electrolyte system;

FIG. 8 is a graph of the open circuit voltage as a function of the ratio of Br⁻ to Cu⁺¹;

FIG. 9 is a cyclic voltammogram for copper bromide systems at different bromide concentrations; and

FIG. 10 is a graph of cell potential of an all copper battery employing a slurry electrode with constant current cycling.

### DETAILED DESCRIPTION

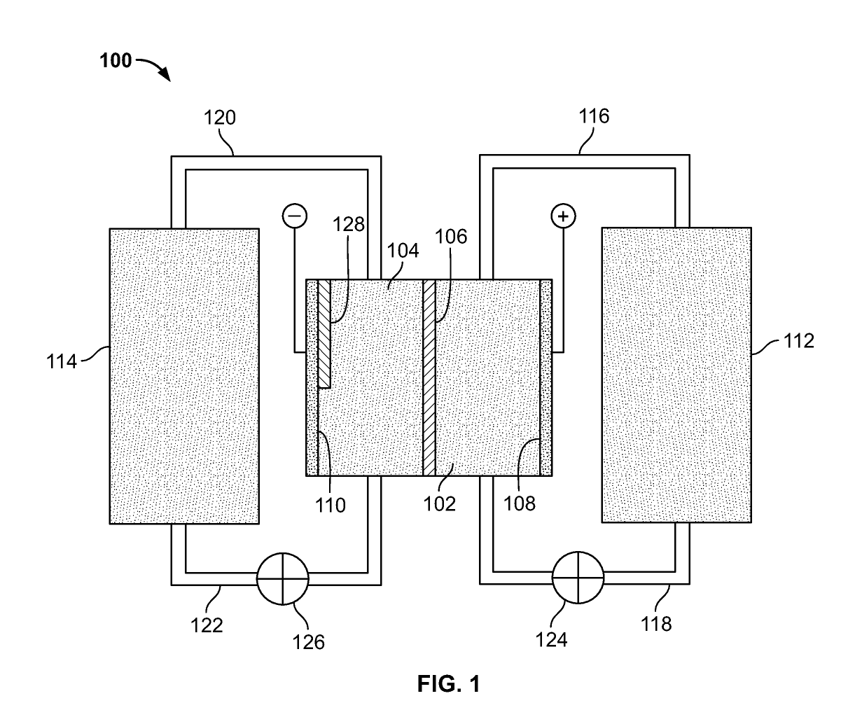

FIG. 1 illustrates an embodiment of a copper flow cell system 100 suitable for use in connection with aspects of the present technology. Flow cell 100 includes two half-cells 102 and 104 separated by a separator 106. Half cells 102 and 104 include electrodes 108 and 110, respectively, in contact with an electrolyte such that an anodic reaction occurs at the surface of one of the electrodes and a cathodic reaction occurs at the other electrode. Electrolyte flows through each of the half-cells 102 and 104 as the oxidation and reduction reactions take place. In FIG. 1, the cathodic reaction takes place in half-cell 102 at electrode 108 (which is referred to herein as the positive electrode or the cathode), and the anodic reaction takes place in half-cell 104 at electrode 110 (which is referred to herein as the negative electrode or the anode).

The electrolyte in half-cells 102 and 104 flows through the system to storage tanks 112 and 114, respectively, and fresh/regenerated electrolyte flows from the tanks back into the half-cells. In FIG. 1, the electrolyte in half-cell 102 flows through pipe 116 to holding tank 112, and the electrolyte in tank 112 flows to the half-cell 102 through pipe 118. Similarly, the electrolyte in half-cell 104 can flow through pipe 120 to holding tank 114, and electrolyte from tank 114 flows through pipe 122 to half-cell 104. The systems can be configured as desired to aid or control the flow of electrolyte through the system and may include, for example, any suitable pumps or valve systems. In the embodiment depicted in FIG. 1, the system includes pumps 124 and 126 to pump the electrolyte from tanks 112 and 114, respectively to the half-cells. In some embodiments, the holding tank can segregate electrolyte that has flowed through the respective cells from electrolyte that has not. However, mixing discharged or partially discharged electrolyte can also be performed.

Electrodes 108 and 110 can be coupled to either supply electrical energy or receive electrical energy from a load or source. Other monitoring and control electronics, included in the load, can control the flow of electrolyte through half-cells 102 and 104. A plurality of cells 100 can be electrically coupled (“stacked”) in series to achieve higher voltage or in parallel in order to achieve higher current.

The electrolytes for the half-cells 102 and 104 are chosen to provide a suitable source of the ions required to carry out the reactions in each half-cell. In accordance with the present technology, the negative electrode employs the Cu¹⁺/Cu⁰ redox couple. Copper plates out (e.g., copper plating 128 in FIG. 1) onto the negative electrode 110 in half-cell 104 during charging and Cu¹⁺ is released upon discharge. The electrolyte in the negative electrode is also referred to herein as the anolyte. The anolyte may be any suitable salt including, but not limited to, the chloride, bromide, iodide, sulfate, nitrate salts or a combination of two or more thereof. In one embodiment, the salt solution comprises a halide electrolyte. The halide can be chloride, bromide, or iodide. In one embodiment, the halide is bromide. Cu¹⁺ is generally air sensitive and readily oxidized to Cu²⁺. It has been found, however, that Cu¹⁺ is stabilized in an electrolyte with an excess concentration of anions. In one embodiment, halide anions are employed in the electrolyte. In one embodiment, the ratio of halide to copper ions is about 5:1 or greater; about 6:1 or greater; about 7:1 or greater; etc. In embodiments the ratio of halide ion (Br⁻ or Cl⁻) to Cu⁺¹ is from about 3.5:1 to 16:1; from about 5:1 to about 12:1; even from about 7:1 to about 10:1. In still other embodiments, the halide ion to Cu⁺¹ ratio is from about 9:1 to about 16:1; from about 10:1 to about 15:1; even from about 11:1 to about 13:1. Here as elsewhere in the specification and claims, numerical values may be combined to form new and non-disclosed ranges.

Here as elsewhere in the specification and claims, numerical values can be combined to form new and non-disclosed ranges.

The electrolyte can be provided as salt solution of the ions of interest (e.g., an all copper chloride solution) or a mixture of salt solutions. For example, the electrolyte may be a mixture of a copper halide salt and an acid such as the hydrogen halide, sodium halide, potassium halide, etc. In the copper-halide system, it may be advantageous to have an electrolyte pH of less than two, and preferably a pH close to zero, i.e., an acidic electrolyte. Having a more acidic electrolyte provides for a higher ionic conductivity in the electrolyte (the proton is the most mobile ion in aqueous solutions). It is also possible that a more acidic electrolyte enhances the solubility of Cu halide, regardless of the total halide concentration. When coupled with a positive electrode, a more acidic electrolyte provides the additional advantage of enhancing the solubility of the CuCl. Generally in a copper system, the highly acidic electrolyte does not pose any problems to the cell. There is a potential disadvantage in some cells of hydrogen evolution.

The copper ions for the negative electrode can be initially provided as a solution with Cu²⁺ ions and initially converted to Cu¹⁺. This can be accomplished by applying potential across the cell to reduce the Cu²⁺ to Cu¹⁺. In another embodiment, copper powder can be added to the system, and the copper powder reacts with the Cu²⁺ ions and the copper powder and Cu²⁺ ions are converted to Cu¹⁺ to provide a solution that is all Cu¹⁺.

The concentration of the salt providing the Cu²⁺ ions (e.g., CuCl₂, CuBr₂, CuI₂, etc.) may be from about 0.01 M to about 10 M, about 0.05 M to about 5 M, even about 0.1 M to about 1 M, and the concentration of the salt providing the Cu⁺ ions (e.g., CuCl, CuBr, CuI, etc.) may be from about 0.01 M to about 10 M, about 0.05 M to about 5 M, even about 0.1 M to about 1 M.

In one embodiment, the electrolyte in the negative half-cell comprises copper bromide. The concentration of the copper bromide may be from about 0.1 M to about 5M; from about 0.5 M to about 2 M; from about 0.7 M to about 1.5 M. In one embodiment, the concentration of the copper bromide is about 1 M. At room temperature, 1 M copper bromide is near the limit of solubility. Higher concentrations of copper bromide may be employed at higher temperatures.

The positive electrode may employ any suitable redox couple as desired for a particular purpose or intended application. Examples of suitable redox couples for the positive electrode include, but are not limited to, the Fe^{2+/3+} couple, Cl⁻/Cl₂ couple, Br⁻/Br₂ couple, V^{4+/5+} couple, Cu^{1+/2+} couple, etc. In one embodiment, the cell comprises an all copper system, and the positive electrode employs the Cu^{1+/2+} couple. The electrolyte used for the redox reactions at the positive electrode is any suitable salt solution for the desired redox couple. This electrolyte is also referred to herein as the catholyte. In one embodiment, the catholyte comprises a source of bromine and bromide (Br⁻) ions, e.g., HBr. In one embodiment, the catholyte comprises a source of chlorine and chloride (Cl⁻) ions, e.g., HCl. In one embodiment, the catholyte comprises a source of V⁴⁺ and V⁵⁺ ions, e.g., V₂O₅. In one embodiment, the catholyte comprises a source of ferrous (Fe²⁺) and ferric (Fe³⁺) ions, e.g., FeCl₃. The concentration of the salt providing the ions of the catholyte may be from about 0.01 M to about 10 M, about 0.05 M to about 5 M, even about 0.1 M to about 1 M, and the concentration of the salt providing the Cu⁺ ions (e.g., CuCl, CuBr, CuI, etc.) may be from about 0.01 M to about 10 M, about 0.05 M to about 5 M, even about 0.1 M to about 1 M.

The electrolytes in the system may be provided to control the ratio of Br⁻ to Cu⁺¹ or Cl⁻ to Cu⁺¹. In embodiments the ratio of halide ion (Br⁻ or Cl⁻) to Cu⁺¹ is from about 3.5:1 to 16:1; from about 5:1 to about 12:1; even from about 7:1 to about 10:1. In still other embodiments, the halide ion to Cu⁺¹ ratio is from about 9:1 to about 16:1; from about 10:1 to about 15:1; even from about 11:1 to about 13:1. Here as elsewhere in the specification and claims, numerical values may be combined to form new and non-disclosed ranges.

While hydrogen evolution is thermodynamically favorable with regards to the reduction of Cu⁺¹ to Cu⁰ in a bromide electrolyte, hydrogen evolution on copper is kinetically hindered. As a result, the coulombic efficiency for copper deposition/stripping is ≈100%; all of the current passed goes to the copper reaction, and essentially none goes to hydrogen evolution. Thus, in an all copper/halide system, it may not be necessary to replenish the electrolyte because there is generally little to no hydrogen evolution at the electrode that results in depletion of the electrolyte. This result is due to the high concentration of halide, e.g., bromide ion, in the electrolyte.

However, in certain electrolytes a highly acidic electrolyte may increase the likelihood of hydrogen evolution (2H⁺+2e⁻ →H₂) as a competing reaction at the negative electrode. If hydrogen evolution occurs, the coulombic efficiency of the battery will be less than 100% as the hydrogen gas evolved is lost from the system so the hydrogen cannot be re-oxidized. As a result, the battery will become imbalanced, i.e., the positive and negative sides of the battery will not be at the same state of charge. Also, the pH of the electrolyte will rise as hydrogen evolution occurs. For example, with the positive electrode, Cu⁺² would build up in the positive electrolyte if hydrogen evolution occurs at the negative electrode and precipitation may occur which could then cause battery failure and the electrolyte, and possibly the electrodes, would have to be replaced. Thus, it will be appreciated that when a system is used that will experience hydrogen evolution, the anolyte may have to be replenished from time to time to keep the concentration at a suitable or useful level. In this embodiment, solid copper in the form of powder, flakes, etc., may be added into the copper solution.

In one embodiment, a copper flow battery includes an anolyte that comprises an additive for reducing hydrogen evolution at the negative electrode. Hydrogen evolution at the negative electrode (e.g., electrode 110) reduces the coulombic efficiency of the battery, which also reduces the watt-hr efficiency. Additionally, hydrogen evolution also causes the pH of the electrolyte to rise, which results in a ferric ion in the electrolyte precipitating out as ferric hydroxide. Suitable hydrogen evolution suppressing additives include, but are not limited to boric acid, heavy metals, and organic materials such as are suitable as surfactants and corrosion inhibitors. Coulombic efficiency can be evaluated by plating copper onto graphite substrates and subsequently stripping the copper off the graphite until the current falls below 10 μA. The coulombic efficiency is equal to the coulombs passed during stripping divided by the coulombs passed during plating.

In one embodiment, the negative electrolyte comprises a metal additive suitable for suppressing hydrogen formation at the negative electrode. Examples of suitable heavy metals that may suppress hydrogen evolution at the negative electrode include, but are not limited to, Pb, Bi, Mn, W, Cd, As, Sb, Sn, combinations of two or more thereof, and the like. While not being bound to any particular theory, the metal additives may facilitate the formation of dendrite-free deposits and may be co-deposited on the anode along with copper. On discharge, the metals are stripped with the copper and returned to the electrolyte solution. The heavy metal additive may be present in an amount of from about 0.0001 to about 0.1 M. In another embodiment, the heavy metal additive may present in an amount of from about 0.001 to about 0.05 M. In still another embodiment, the heavy metal additive may be present in an amount of from about 0.01 to about 0.025 M.

The pH of the anolyte with the hydrogen evolution suppressing agent may be from about 1 to about 6. The operating pH of the solution may be selected as desired for a particular purpose or intended use. In one embodiment, the pH of the anolyte is from about 2 to about 4. In another embodiment, the pH of the anolyte is from about 1 to about 1.8.

The electrodes (e.g., electrodes 108 and 110) employed in the copper flow battery can be selected from any suitable electrode material. In one embodiment, the electrodes are graphite electrodes. The electrodes can be configured in a particular shape as desired for a particular purpose or intended use. In one embodiment the electrodes can be provided with a substantially planar surface. In one embodiment, the negative electrode can be provided with a contoured or shaped surface to provide a larger surface area. Additionally, the electrodes can be a porous foam, grid, or mesh.

The separator (e.g., separator 106) can be chosen as desired for a particular purpose or intended use. In one embodiment, the membrane is a porous membrane without any active ion-exchange material. In another embodiment, the membrane is an ion-selective porous membrane. In one embodiment, the membrane can be an anionic membrane. As previously described, an anionic membrane may be suitable where the system employs an anolyte and catholyte having different pH levels and it is necessary to keep the electrolytes from cross mixing.

In one embodiment, the copper flow battery and system is provided to decouple the power and energy at the negative electrode. In the system shown in FIG. 1, the energy stored and the power delivered can be limited by the thickness of the copper plating that is achieved. In an embodiment for decoupling the power, copper plating is carried out on a substrate that can be circulated through the cell.

In one embodiment a system for decoupling the power/energy at the anode comprises employing a slurry electrode or fluidized bed electrode as the negative electrode. The slurry comprises particles sufficient to impart electrode conductivity to the electrolyte. Suitable particles include carbon-based, e.g., graphitic, particles, copper particles, copper coated glass or ceramic particles, or a combination of two or more thereof. The copper coated particles can also include an electrically conductive particle as the core. In one embodiment, the copper coated particles comprise carbon-based particles, copper particles, or titanium particles coated with copper. The copper coated particles can be particles comprising copper plating. Over time, the copper particles and copper coating can be depleted, and the use of copper coated particles provides a slurry that still exhibits electrical conductivity via the electrically conductive particles. In one embodiment, a slurry electrode comprises copper particles suspended in a sufficient volume of electrolyte to enable the slurry to be pumped through the battery, while still maintaining particle to particle contact for electrical conductivity. The particle size can be chosen as desired. In one embodiment, the particles can have a particle size of from about 0.01 micron to about 1500 microns; from about 0.1 microns to 1000 micron, from about 1 microns to about 500 microns; from about 5 microns to about 250 microns; from about 10 microns to about 150 microns; even from about 50 microns to about 100 microns. In one embodiment, the particles have an average particle size of about 100 microns. In embodiments, the particles used as the electrode for a slurry electrode may have a primary particle size of from about 0.01 microns to about 2 microns; from about 0.025 microns to about 1.5 microns; even from about 0.05 microns to about 1 micron. Here as elsewhere in the specification and claims numerical values can be combined to form new or non-disclosed ranges. Without being bound to any particular theory, using larger particles may reduce particle to particle contacts and increase the conductivity of the slurry. Using a slurry electrode provides a high surface area to minimize the over potential for copper plating/dissolution and a higher cycle life (compared to plating on a flat electrode).

For storage purposes, it may be desirable to de-water the slurry outside of the electrochemical cell. This would minimize the total volume of material to be stored and the total volume of electrolyte needed, and lower the corrosion of copper while in storage. The electrolyte removed in de-watering can then be used to re-slurry the conductive particles entering the battery.

In another embodiment, the negative electrode can comprise or be formed from a material onto which the copper will plate. In embodiments, the negative electrode may comprise coils of steel onto which the copper will be plated. A coil of steel (where the steel is about 1.2 m wide and up to 1,000 m long) that is plated to a thickness of 10 um may provide over 90,000 Ahr of storage. Other variations of the coil approach can be employed. For example, instead of a steel coil, the plating can be done on a metalized polymer film. The polymer film can be coated with any suitable metal such as with a thin layer of copper or other inert metal such as gold. This could reduce the weight, complexity and cost of a large system. In other embodiments, the negative electrode comprises or is formed from copper, silver, titanium, gold, etc., or a combination of two or more thereof. In embodiments, the negative electrode comprises copper, titanium, or a combination thereof. The electrode may be formed from the desired metal or may be provided by another material comprising a coating of the desired metal (e.g., carbon-based or graphite electrode coated with a metal, glass or ceramic coated with the desired metal, etc.). The negative electrode comprising a metal onto which copper can be plated can be provided in any suitable form for the reactions including, as a sheet or planar structure, a contoured structure, a mesh screen, a coil, a wire, or combinations of two or more thereof may be used.

A decoupled power/energy system may be particularly suitable for larger copper flow battery systems. Smaller systems or certain applications may not require a decoupled power and energy system. In these cases, negative electrode substrates such as graphite felt might be reasonable if designed appropriately for uniform current distribution or reaction distributions from current collector that decrease towards the membrane.

A copper flow battery can be operated at a current density of about 1 to about 1000 mA/cm². In one embodiment, the battery is operated at a current density of about 50 to about 200 mA/cm². In another embodiment, the battery is operated at a current density of about 100 mA/cm². The temperature of the electrolyte can be from about 0° C. to about 60° C. In one embodiment, the temperature of the bath is about 25° C. It will be appreciated that, even if operating at about room temperature (e.g., about 25° C.), the temperature of the bath may increase during operation.

A copper flow battery in accordance with aspects of the present technology can have an energy to power ratio of from about 0.1 to over 10 with a de-coupled system. In one embodiment, the energy to power ratio is from about 1 to about 4. In another embodiment, the energy to power ratio is from about 1 to about 2. The plating capacity of the system with a planar substrate can be from about 50 mAh/cm² to about 500 mAh/cm². In one embodiment, the plating capacity of the system may be from about 100 mAh/cm² to about 200 mAh/cm². Larger plating capacities increase the discharge time and, consequently, the energy to power ratio of the system. In embodiments, the battery has a plating efficiency of from about 85% to about 100%.

The watt-hour efficiency of the bath can be from about 40 to about 85%. In one embodiment, the watt-hour efficiency is from about 45 to about 55%. As used herein, watt-hour efficiency refers to the voltage on discharge divided by the voltage on charge at equal currents during charge and discharge of the cell. The voltage on charge refers to the open circuit potential minus the sum of the kinetic, ohmic, and mass transfer overpotentials on charging of the cell. The voltage on discharge refers to the open circuit potential minus the sum of the kinetic, ohmic, and mass transfer overpotentials on discharging of the cell.

A copper flow battery in accordance with aspects of the present technology can be charged and discharged repeatedly and is suitable as a battery for temporary storage of electric power in a variety of applications. A copper flow battery may be used in a wide variety of applications including, but not limited to, use as part of an energy transmission grid, power plants, and the like.

As used herein, individual numerical values can be combined to form additional and/or non-disclosed ranges.

Aspects of the technology are further understood with respect to the following examples. The examples illustrate possible embodiments of the technology and are not intended to limit the technology or scope of the appended claims.

### EXAMPLES

### Example 1: Copper in Chloride and Sulfate Electrolytes

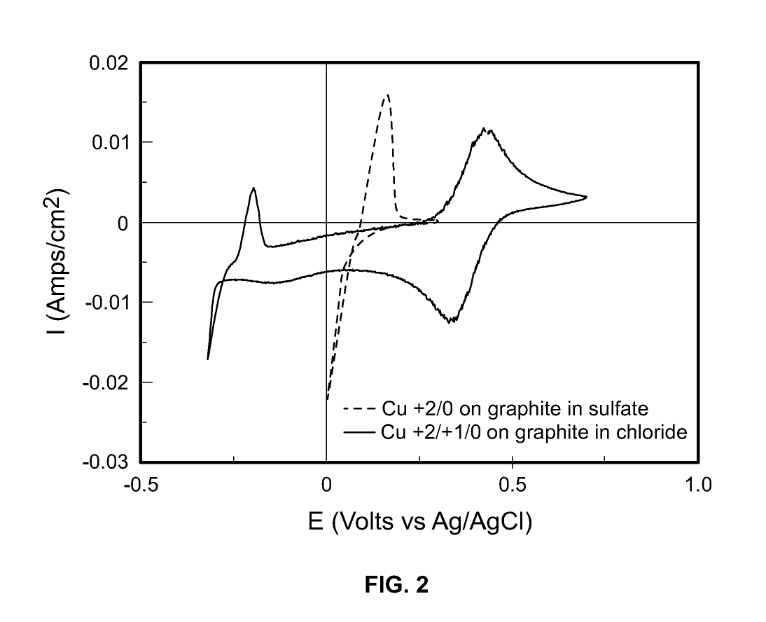

Plating was conducted in a 0.5 M CuCl₂, with 1 M NH₄Cl and 5 M NaCl added against an Ag/AgCl reference electrode was used and all potentials were relative to this reference. The cyclic voltammograms of copper in chloride and sulfate electrolytes are shown in FIG. 2. At the most positive potentials, Cu was present as Cu⁺² complexed with chloride to form CuCl₄²⁻. At ca. 0.375 V, Cu²⁺ was reduced to Cu⁺ in the form of a chloride complex. At ca. −0.25V, Cu⁺ was reduced to Cu⁰. On the reverse scan, Cu⁰ was oxidized to Cu⁺¹ at potentials more positive than −0.25V, and Cu¹⁺ was oxidized to Cu⁺² at potentials more positive than ca. 0.375V. The reduction of Cu⁺¹ to Cu⁰ in the presence of excess Cl⁻ was shifted by ca. 200 mV more negative relative to the ‘book’ value given in the following equation:

CuCl₍ₛ₎+e⁻→Cu⁰+Cl⁻ E⁰=0.14 V vs. NHE, −0.06 V vs. Ag/AgCl

In the sulfate electrolyte, only the Cu⁺²↔Cu⁰ reactions occurred, as shown in the following equation:

Cu²⁺+2e⁻→Cu⁰ E⁰=0.34 V vs. NHE, +0.14 V vs. Ag/AgCl.

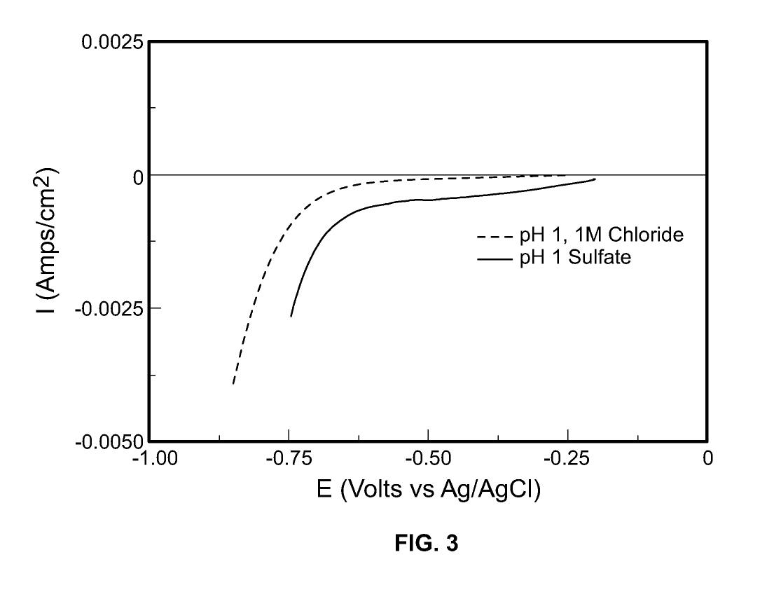

In FIG. 3, the hydrogen evolution on copper at pH=1 in chloride and sulfate electrolytes is shown. The data shown in FIG. 3 shows that while hydrogen evolution is thermodynamically favorable with regards to the reduction of Cu⁺¹ to Cu⁰ in a chloride electrolyte, hydrogen evolution on copper is kinetically hindered. As a result, the coulombic efficiency for copper deposition/stripping was ≈100%, i.e., all of the current passed went to the copper reaction, and essentially none went to hydrogen evolution. This result was due to the high concentration of chloride ion in the electrolyte. In FIG. 2, the Cu¹⁺ to Cu⁰ reaction was observed at potentials more negative than −0.25V vs Ag/AgCl. In FIG. 3, the hydrogen evolution current in the chloride electrolyte was essentially zero at this potential, whereas in the sulfate electrolyte there is a noticeable hydrogen evolution current (ca. 0.5 mA/cm²) at −0.25V. The thermodynamic potential for hydrogen evolution in a pH 1 electrolyte relative to the Ag/AgCl (3 M Cl⁻) reference electrode was ≈−0.25V.

### Example 2: Copper-Iron Chloride Cell

The initial electrolyte concentration on both sides of the cell of Example 2 was 0.5 M FeCl₂, 0.5 M CuCl₂, with 1 M HCl, 2 M KCl. There were ten times as many chloride ions than copper ions in the electrolyte in order to lower the pH. Two different separators were used in the cell, Nafionº117 and a microporous separator, Daramic 175 SLI Flatsheet Membrane. The cell was initially held at 0.7V to reduce all of the Cu²⁺ to Cu¹⁺on the negative side before converting Cu¹⁺to Cu⁰. At this point, the Cu⁺¹ concentration was 0.5 M, however, due to the excess of Cl⁻ ion present and the pH, CuCl did not precipitate.

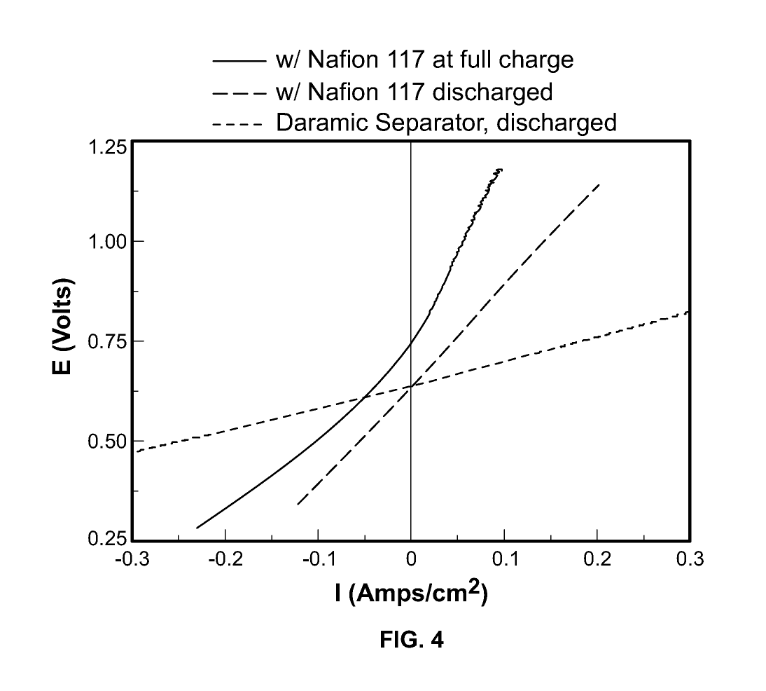

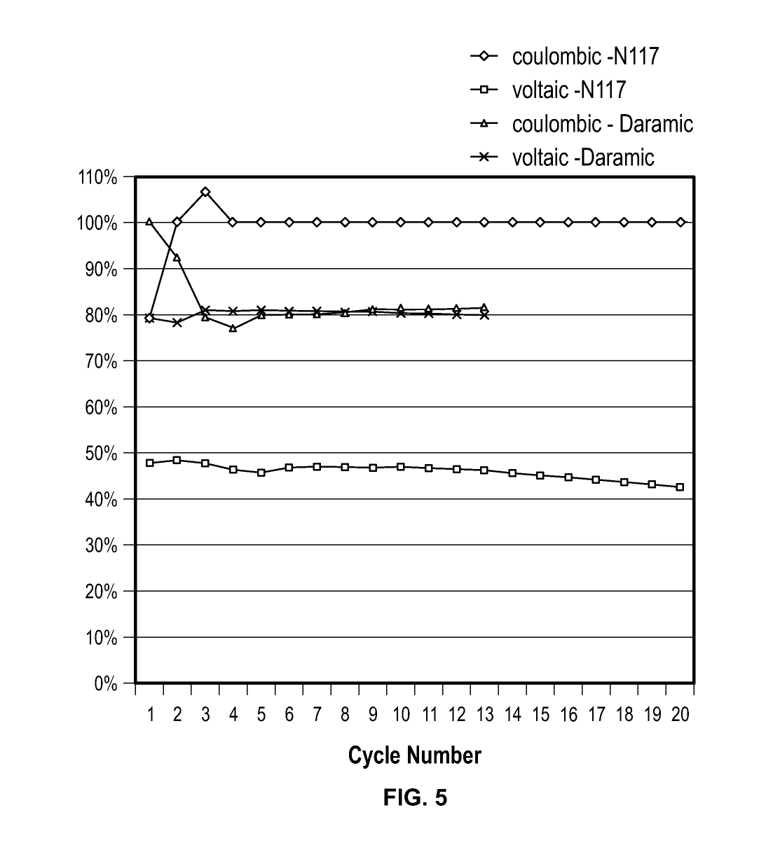

In FIGS. 4 and 5, the results are shown for prototype batteries using the Cu^{1+/0} negative couple and the Fe^{2+/3+} positive couple. The cell area was 5 cm² and the electrodes were carbon felt (⅛″ thick) pre-treated with Fenton's reagent to improve wettability. A ‘flow-through’ geometry was used with an electrolyte flow rate of 30 ml/min.

FIG. 4 shows the variation in cell potential with state of charge, 0.75 V when the cell is charged and 0.625 V when the cell was discharged. The cell with the Daramic separator had a much lower overall resistance. Impedance analysis indicated that the lower resistance was primarily due to the ionic resistance of the separator (about 0.1 ohm for the Daramic, about 0.4 ohm for the Nafion membrane). The electrode polarization in both cells was similar.

In FIG. 5, the results derived from a one hour charge/discharge cycles at 100 mA/cm² are shown. A charge cut-off of 1 V and a discharge cut-off of 0.25V were used. For the full charge/discharge time of one hour (100 mAh/cm²), the Cu¹⁺ ion concentration in the negative electrolyte varied between 0.5 and 0.25 M. Twice as much positive electrolyte versus negative electrolyte was used. As a result, after completing converting the initial Cu²⁺ to Cu¹⁺ reduction, the positive electrolyte was 0.375 M in Fe²⁺ and 0.125 M in Fe³⁺. After charging, these concentrations reversed (0.125 M Fe²⁺ and 0.375 M Fe³⁺). The voltaic efficiency of the cell with the Daramic separator was much higher than that with Nafion (80% vs ≈45%), in agreement with FIG. 3. However, the coulombic efficiency was lower with Daramic (80% vs 100% for Nafion 117). The coulombic efficiency observed with Nafion as a separator confirms that hydrogen evolution is negligible at the negative electrode potential. The coulombic efficiency result with Daramic is consistent with the fact that the porous Daramic separator allows ions to diffuse from one side of the cell to the other much more readily than does Nafion which is a non-porous, cation conducting membrane. The ion crossover of Fe³⁺ and Cu²⁺ from the positive to the negative side of the cell, and the crossover of Cu¹⁺ from negative to positive all contribute to lowering the coulombic efficiency. The cell with the Daramic separator had a higher Whr efficiency of ≈65% vs ≈45% for the cell using Nafion 117.

### Example 3: Copper-Bromide Cell

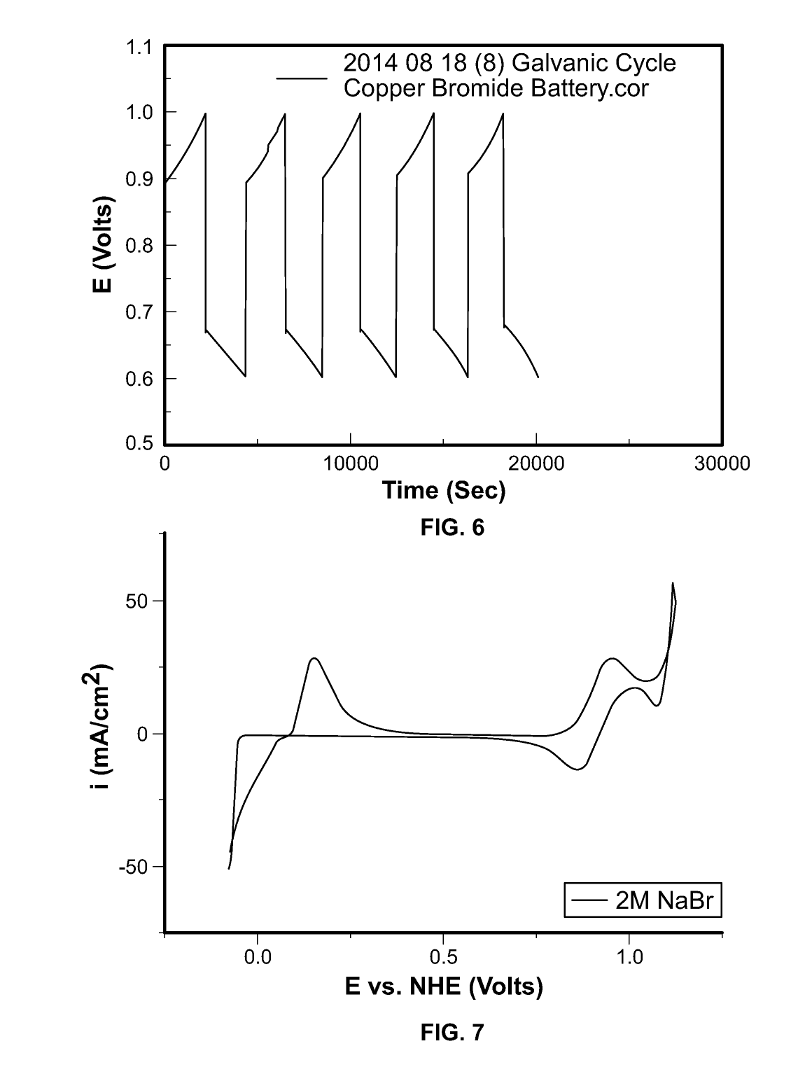

FIG. 6 shows a bromide system behaving in a similar fashion to that of the chloride system of FIG. 2. In this example, a graphite working electrode was used with an electrolyte comprising 0.5 M CuBr₂ with 6 M NaBr. The copper plating potential of the bromide system was essentially the same as that of the chloride. In the bromide electrolyte, the Cu²⁺/Cu¹⁺ redox occurs at a more positive potential than in the chloride electrolyte (ca. 0.55 V vs 0.375V). At still more positive potentials in the bromide electrolyte, Br₂ was generated. When the bromine/bromide reaction was used as the positive couple, the cell potential was ≈1V.

### Example 4: Copper-Bromide Cell

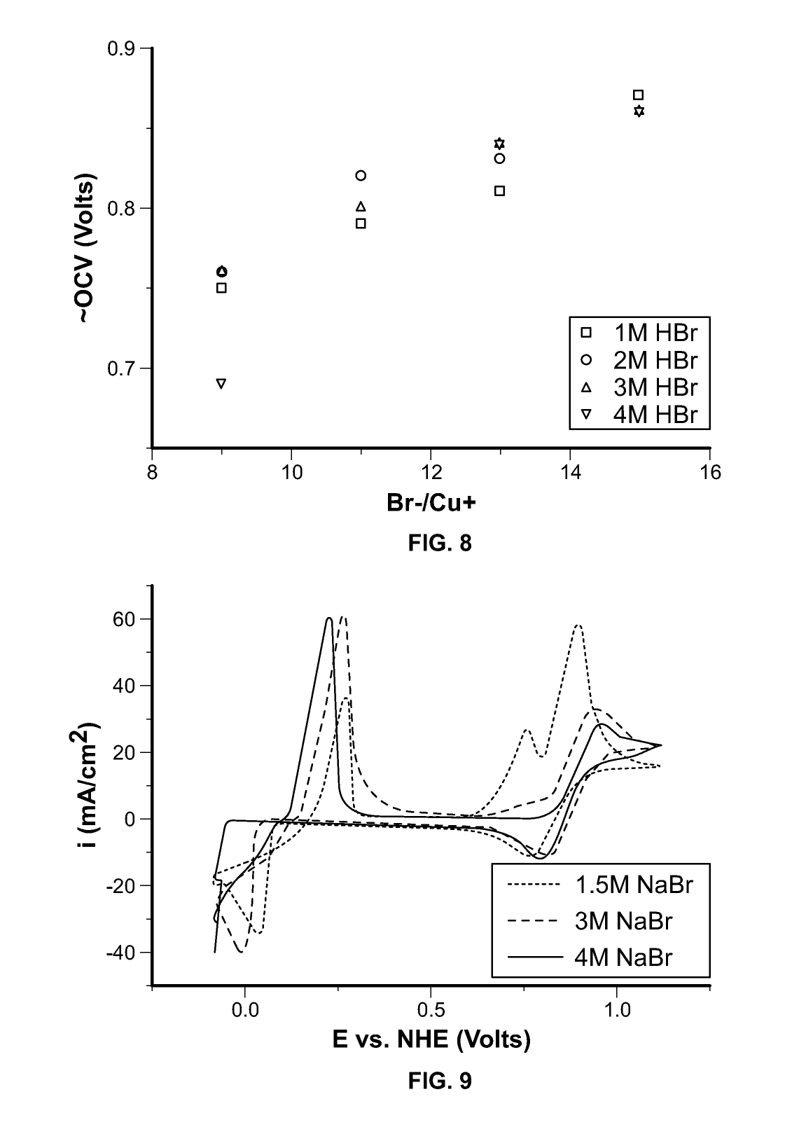

Copper-bromide systems were run to evaluate the effect of the bromide ion to copper(I) ratio (Br⁻/Cu⁺¹) on the open circuit voltage (OCV) of the battery. FIG. 7 shows a cyclic voltammogram of a Cu/Br system with 2M NaBr, 4M HBr, and 0.5M CuBr. The cycles were conducted at a scan rate of 10 mV/s for 5 cycles with only the last cycle shown. Similar cycles were performed with 1M HBr, 2M HBr, and 3M HBr. The approximate OCV was determined from cyclic voltammograms of the different systems (such as that shown in FIG. 7. The average of the two peak potentials of the Cu^{1+/2+} reaction was considered the approximate standard potential of the reaction and the zero crossing on the positive going sweep was used to approximate the standard potential of the Cu^{0/1+} reaction. The OCV as a function of Br⁻/Cu⁺¹ is shown in FIG. 8. It can be seen that the higher the Br⁻/Cu⁺ ratio results in a higher approximate OCV. These tests indicate that the OCV of a battery with an electrolyte composition of 4M NaBr, 1M HBr, and 2M Cu⁺¹ will not be as high as that achieved by a 6M NaBr, 1M HBr, 2M Cu⁺¹ electrolyte or a 5M NaBr, 1M HBr, 2M Cu¹⁺. As a result, there may be a trade-off to be considered between the electrolyte cost and the cell OCV.

At lower Br⁻/Cu⁺ ratios, a second Cu^{1+/2+} oxidation peak appears. This indicates multiple copper(I) bromide complexes are present. FIG. 9 shows cyclic voltammograms for 1M HBr, 0.5M CuBr solutions with increasing concentrations of NaBr to vary the Br⁻ concentration. It appears that a lower bromide content causes a second oxidation Cu^{1+/2+} peak to form at a lower potential. Thus, using higher Br⁻/Cu⁺¹ ratios may avoid the formation of complexes that react at lower voltage. At the same time, however, a higher copper(I) concentration should be used in order to keep the volume and cost of the electrolyte low. Similar results are expected with chloride; higher ratios should increase the open circuit potential and prevent the formation of complexes that react at lower voltages.

### Example 5: Copper-Bromide System with Slurry Electrodes

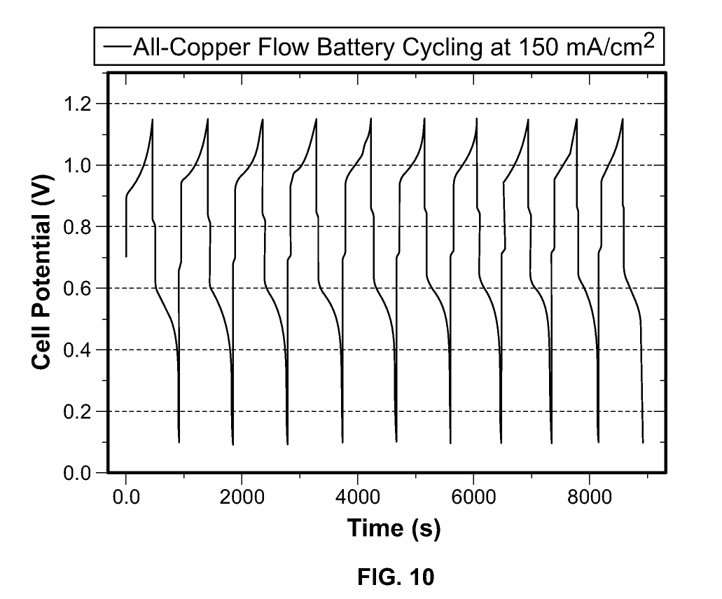

Constant current cycling of an all-copper battery was done with a copper-bromide electrolyte system with a carbon slurry negative electrode. The electrolyte composition was 4M NaBr, 1M HBr and 1M CuBr. FIG. 10 shows the results of the constant current cycling for a number cycles at 150 mA/cm² on charge and discharge. The slurry electrode is shown to have cycled for 10 cycles.

Although aspects of a copper flow battery have been shown and described with respect to certain embodiments, it is understood that equivalents and modifications may occur to others skilled in the art upon reading and understanding the specification. The present technology includes all such equivalents and modifications.

What is claimed is:

1. A copper flow redox cell comprising:
a cathodic half-cell comprising a first electrolyte providing a source of ions for a cathodic redox couple and an electrode disposed within the cathodic half-cell;
an anodic half-cell comprising a second electrolyte providing a source of Cu¹⁺ ions and an electrode disposed within the anodic half-cell; and
a separator between the first and second half-cells.

2. The copper flow redox cell of claim 1, wherein the first electrolyte comprises a solution providing an ionic species suitable for a Fe²+/3+ couple, a Br⁻/Br₂ couple, a Cl⁻/Cl₂ couple, a V^{4+/5+} couple, a Cu^{1+/2+} couple, or a combination of two or more thereof.

3. The copper flow redox cell of claim 1, wherein the concentration of first electrolyte agent is from about 0.01 M to about 10 M.

4. The copper flow redox cell of claim 1, wherein the pH of the first electrolyte is from about 0 to about 2.

5. The copper flow redox cell of claim 1, wherein the electrode in the anodic half-cell comprises a slurry comprising electrically conductive particles, copper particles, copper coated particles, or a combination thereof.

6. The copper flow redox cell of claim 5, wherein the electrically conductive particles are chosen from graphite particles.

7. The copper flow redox cell of claim 5, wherein the electrode in the anodic half-cell comprises copper coated particles chosen from graphite, copper, titanium, or a combination of two or more thereof.

8. The copper flow redox cell of claim 1, wherein the electrically conductive particles have a particle size of from about 1 micron to about 1500 microns.

9. The copper flow redox cell of claim 1, wherein the electrode in the anodic half-cell comprises a metal chosen from copper, silver, titanium, gold, or a combination of two or more thereof.

10. The copper flow redox cell of claim 1, wherein the second electrolyte comprises a source of Fe²⁺ and Fe³⁺ ions.

11. The copper flow redox cell of claim 1, wherein the second electrolyte comprises a copper halide.

12. The copper flow redox cell of claim 1, wherein the second electrolyte comprises copper bromide.

13. The copper flow redox cell of claim 12, wherein the ratio of bromide ions to copper ions is about 5:1 or greater.

14. The copper flow redox cell of claim 12, wherein the ration of bromide ions to copper ions is about 3.5:1 to about 16:1.

15. The copper flow redox cell of claim 1, wherein the concentration of second electrolyte agent is from about 0.01 M to about 10 M.

16. The copper flow redox cell of claim 1, wherein the pH of the second electrolyte is from about 0 to about 2.

17. The copper flow redox cell of claim 1, having an energy to power ratio of from about 1 to about 5.

18. The copper flow redox cell of claim 1, having a plating capacity of from about 100 mAh/cm² to about 500 mAh/cm².

19. The copper flow redox cell of claim 1, having a plating efficiency of from about 85% to about 100%.

20. The copper flow redox cell of claim 1, having a watt-hour efficiency of about 40% to about 85%.

21. The copper flow redox cell of claim 1, wherein the temperature of the electrolyte is from about 0° C. to about 60° C. during operation of the cell.

22. The copper flow redox cell of claim 1 comprising;
a first storage tank external to the first half-cell for circulating the first electrolyte to and from the first half-cell; and
a second storage tank external to the second half-cell for circulating the second electrolyte to and from the second half-cell.

23. A battery comprising one or more of the redox flow cells of claim 1.
